(19) United States
(12) Patent Application Publication
(10) Pub. No.: US 2016/0234724 A1
(43) Pub. Date: Aug. 11, 2016

(54) FAST RETURN FROM WIRELESS CIRCUIT SWITCHED NETWORK WHILE IN HIGH SPEED STATE

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/617,796

(22) Filed: Feb. 9, 2015

(51) Int. Cl. H04W 36/00; H04W 36/32

(52) U.S. Cl. CPC H04W 36/0022; H04W 36/32

(57) ABSTRACT

A user equipment (UE) in a high speed state returns back to a frequency on a dedicated network (e.g., LTE) or a different frequency after a circuit switched fallback call is released from another network based on a signal quality of the frequency on the dedicated network. In one instance, it is determined whether the UE is in a high speed state. Based on the determination, the UE searches a selected frequency and/or inter-frequency neighbors, when attempting to return to the dedicated network from a second RAT after a circuit switched fallback (CSFB) call is released from the second RAT.

### BACKGROUND

1. Field

Aspects of the present disclosure relate generally to circuit switched fallback in a wireless communication system, and more particularly, to fast return to a high speed network from a circuit switched network when a UE is in a high speed state.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method of wireless communication includes determining whether a user equipment (UE) is in a high speed state. The method also includes searching a selected frequency, when returning to a first radio access technology (RAT) from a second RAT after a circuit switched fallback (CSFB) call is released from the second RAT, based on whether the UE is in the high speed state.

According to another aspect of the present disclosure, a method for wireless communication includes broadcasting a dedicated neighbor frequency list over a serving cell in a dedicated frequency.

According to another aspect of the present disclosure, an apparatus for wireless communication includes means for determining whether a user equipment (UE) is in a high speed state. The apparatus also includes means for searching a selected frequency, when returning to a first radio access technology (RAT) from a second RAT after a circuit switched fallback (CSFB) call is released from the second RAT, based on whether the UE is in the high speed state.

According to another aspect of the present disclosure, an apparatus for wireless communication includes means for identifying at least one dedicated neighbor frequency. The apparatus may also include means for broadcasting a dedicated neighbor frequency list of the at least one dedicated neighbor frequency over a serving cell in a dedicated frequency.

Another aspect discloses a computer program product for wireless communications in a wireless network having a non-transitory computer-readable medium. The computer-readable medium has non-transitory program code recorded thereon which, when executed by the processor(s), causes the processor(s) to determine whether a user equipment (UE) is in a high speed state. The program code also causes the processor(s) to search a selected frequency, when returning to a first radio access technology (RAT) from a second RAT after a circuit switched fallback (CSFB) call is released from the second RAT, based on whether the UE is in the high speed state.

Another aspect discloses a computer program product for wireless communications in a wireless network having a non-transitory computer-readable medium. The computer-readable medium has non-transitory program code recorded thereon which, when executed by the processor(s), causes the processor(s) to broadcast a dedicated neighbor frequency list over a serving cell in a dedicated frequency.

Another aspect discloses an apparatus for wireless communication and includes a memory and at least one processor coupled to the memory. The processor(s) is configured to determine whether a user equipment (UE) is in a high speed state. The processor(s) is also configured to search a selected frequency, when returning to a first radio access technology (RAT) from a second RAT after a circuit switched fallback (CSFB) call is released from the second RAT, based on whether the UE is in the high speed state.

Another aspect discloses an apparatus for wireless communication and includes a memory and at least one processor coupled to the memory. The processor(s) is configured to broadcast a dedicated neighbor frequency list over a serving cell in a dedicated frequency.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5A-5B are block diagrams illustrating methods for fast return in a high speed state according to aspects of the present disclosure.

FIGS. 6 and 7 are diagrams illustrating examples of hardware implementations for employing a processing system according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

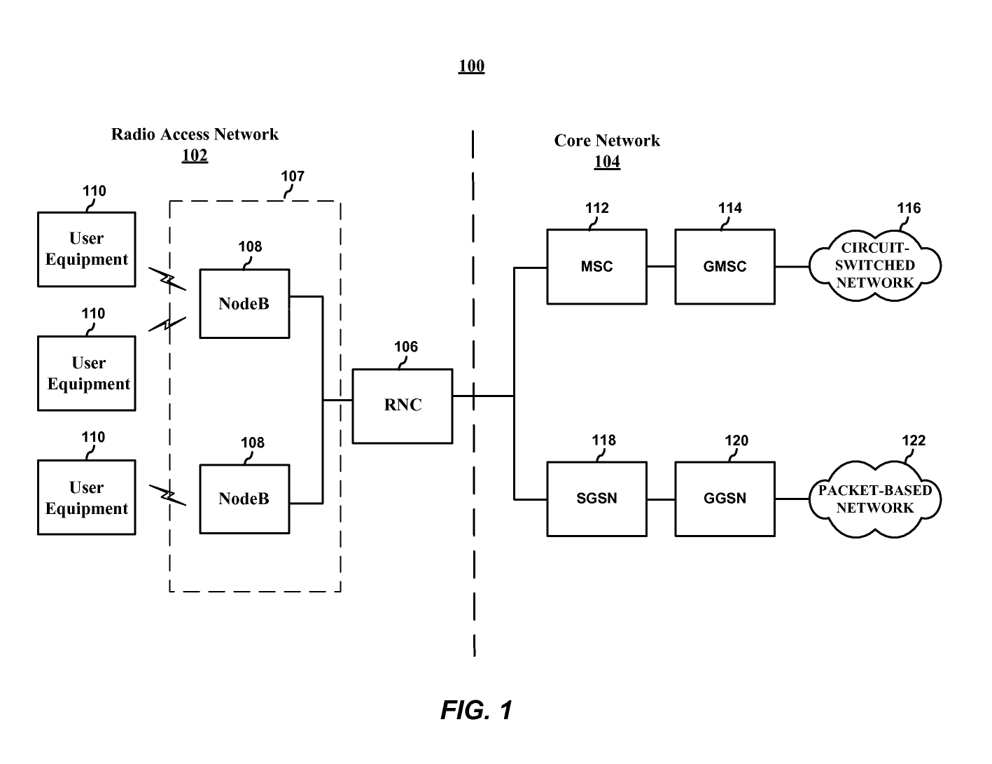

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

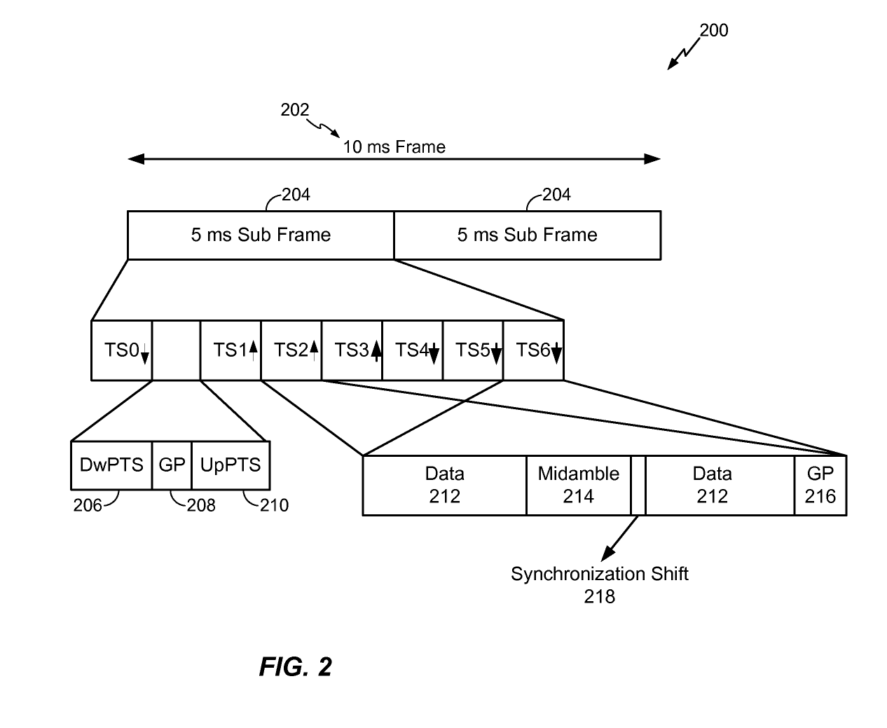

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

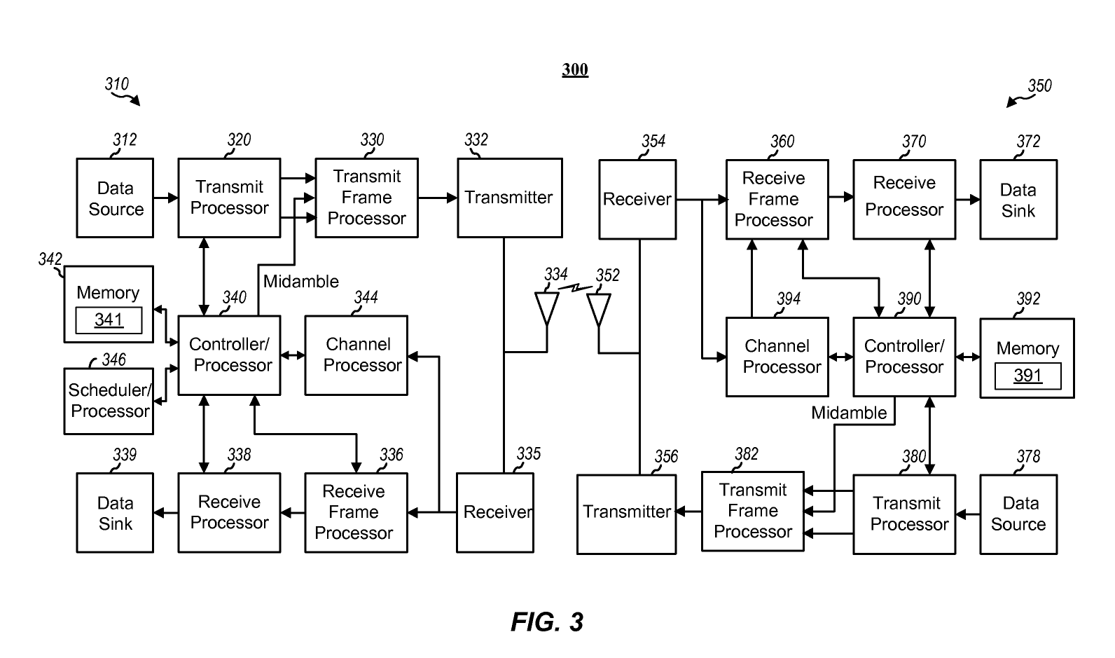

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a high speed state module 391 which, when executed by the controller/processor 390, configures the UE 350 for fast return back to a first RAT when in a high speed state. Additionally, the memory 342 of the node B 310 may store a dedicated neighbor frequency list module 341 which, when executed by the controller/processor 390, configures a serving node B for broadcasting a dedicated neighbor frequency list in a dedicated frequency.

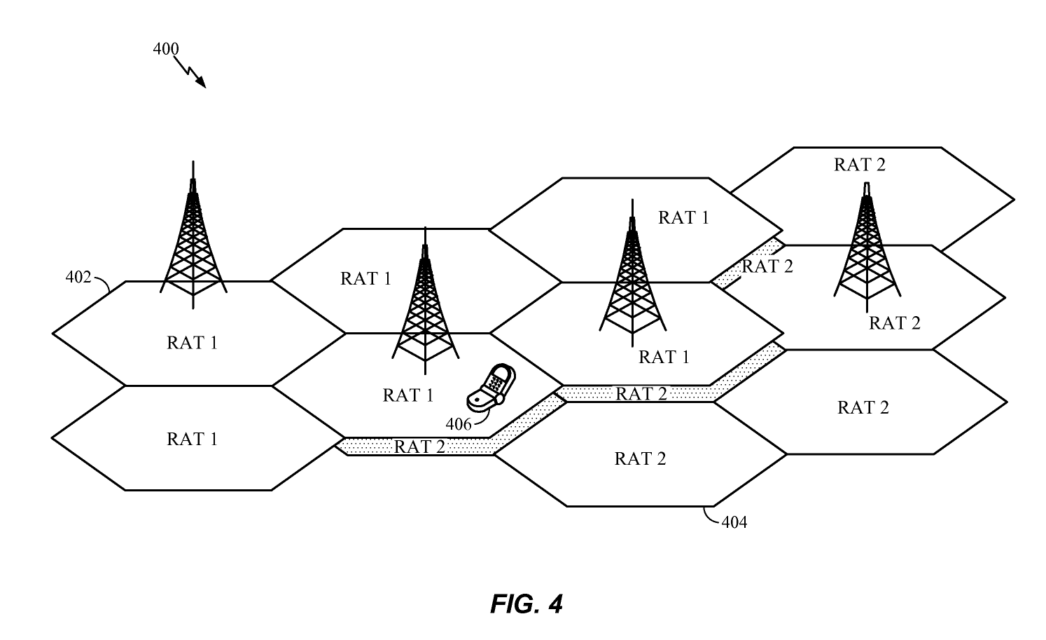

FIG. 4 is a diagram illustrating a mixed network 400 that includes coverage areas of a first RAT 402 (i.e., RAT 1) and a second RAT 404 (i.e., RAT 2). In one example, the RAT 1 cells are 2G/3G cells and the RAT 2 cells are LTE cells. However, those skilled in the art will appreciate that other types of radio access technologies may be utilized within the cells. A user equipment (UE) 406 may move from one cell, such as a RAT 1 cell 402, to another cell, such as a RAT 2 cell 404. The movement of the UE 406 may specify a handover or a cell reselection.

In a system having multiple radio access technologies (RATs), there are times when a particular UE will operate on one system and then switch to other system. Such a switching between systems is called an inter-radio access technology (IRAT) handover (HO) between the two systems. Such handovers may be performed, e.g., for load balancing purposes, coverage holes in one network, or can be based on the type of communication desired by the UE. For example, while camped on a packet switched network, a UE may desire to participate in a circuit switched call. Thus, the UE falls back (i.e., reselects) to the circuit switched network.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system, a UE may be specified to perform a measurement of a neighboring cell. For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

Once the UE has finished using one RAT and is ready to return back to another RAT, the UE “re-selects” to the other RAT. For example, if a UE has completed a voice call on first RAT 402, the UE may be ready to return to the second RAT 404. Accordingly, the UE “re-selects” or otherwise finds a frequency on the second RAT network to enable return to the second RAT system. Such a return may be referred to as a “fast return” (FR) or “standard fast return” when re-selection takes place with assistance from the network.

Circuit switched fallback is a feature that enables multimode user equipments (UEs) that are capable of communicating on a first RAT (e.g., LTE) in addition to communicating on a second RAT (e.g., second/third generation (2G/3G) RAT) to obtain circuit switched voice services while being camped on the first RAT. For example, the circuit switched fallback capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G/2G network, for the circuit switched voice call setup. In some instances, the circuit switched fallback capable UE may be paged for a mobile-terminated (MT) voice call while on LTE, which results in the UE being moved to 3G or 2G for the circuit switched voice call setup.

Upon completion of a circuit switched (CS) voice call, the UE implements a fast return to the LTE network to enable high speed data functions. The UE may perform a blind or non-blind fast return to LTE when receiving a radio resource control (RRC) release message from the circuit switched (CS) RAT. The RRC release message may include redirection information for the UE to return to the LTE network. Additionally, the RRC release message includes covered frequencies.

Dedicated LTE networks have been built to improve the quality of service for UEs moving in a high speed state. For example, a dedicated network may be utilized for high speed trains to improve the quality of service for the user traveling on the train at high speeds. A dedicated LTE network uses dedicated or different LTE frequency(s) compared to macro or public networks. The dedicated frequencies are dedicated for high speed travel. Additionally, no neighbors are configured between dedicated or public LTE frequencies. In one example, high speed is above 300 km/h.

When a circuit switched (CS) call is released in a CS RAT, the UE-based fast return attempts to return to the strongest LTE frequency as stored in the LTE acquisition history. In the case where the macro or public LTE frequency has stronger coverage than the dedicated LTE frequency, the UE may return to the macro or public LTE frequency. This likely results in a high speed state UE, (e.g., a UE traveling at a high speed), leaving the dedicated LTE frequency. For example, if the UE was previously on a first dedicated frequency (f1), after a circuit switched call, the UE may attempt to retune to f1. However, if the strength of fl is too low (i.e., below a threshold), the UE may instead return to a different frequency (e.g., f2, f3), which may or may not be a frequency associated with a dedicated network.

Aspects of the present disclosure are directed to returning a UE in a high speed state back to a dedicated LTE network after a circuit switched fallback (CSFB) call is released from another network. In particular, after a circuit switched fallback (CSFB) voice call is released, the UE determines whether the UE is in a high speed state.

Various techniques may be utilized for determining whether a UE is in a high speed state. In particular, the determining may be based on whether a parameter is above a threshold. For example, a UE measured Doppler frequency (including a filtered Doppler frequency) may be utilized. In particular, when the UE measured or filtered Doppler frequency is above a predefined threshold, the UE may determine it is in a high speed state. Additionally, the speed at which the UE is moving/traveling may be provided from a positioning location receiver (e.g., global positioning system (GPS) receiver) and/or device. When the GPS provided speed is above a predefined threshold, the UE may be determined to be in a high speed state.

Another aspect includes recording the serving frequency and the neighbor frequencies in a UE memory when the UE is in a high speed state. Additionally, in another aspect, when the UE is in a high speed state, it only records the frequency being used. Further, another aspect includes recording only dedicated frequencies in a first database. That is, only those frequencies utilized for a UE moving at a high speed are recorded in the first database. All other LTE frequencies may be recorded in a second, separate database. Alternately, all LTE frequencies (including dedicated frequencies) may be recorded in the second database. The high speed fast return database may be a subset of the common fast return database.

After the UE determines whether it is in a high speed state, the UE selects a frequency to search. If the UE determines it is in a high speed state, the UE may search the prior serving dedicated LTE frequency before the CSFB call. When the signal quality (e.g., measured RSRP (reference signal received power), RSRQ (reference signal receive quality) or SINR (signal to interference plus noise ratio)) of the selected frequency is above a predefined threshold, the UE attempts to return to the dedicated frequency. In one aspect, the UE returns to the dedicated frequency regardless of whether the dedicated frequency is the strongest frequency.

Optionally, when the UE is in a high speed state and the prior dedicated frequency is below a predefined signal strength, the UE may be configured for searching inter-frequency neighbors of the prior dedicated serving frequency. The UE may then return to a dedicated serving frequency of an IRAT frequency neighbor.

When the measured or filtered Doppler frequency is below a predefined threshold or the UE speed provided from the position location receiver is below a predefined threshold, the UE determines it is not in a high speed state. The UE then searches all LTE frequencies (e.g., dedicated and public frequencies) stored in the LTE acquisition history. The UE then return back to the strongest LTE frequency.

In one aspect, a serving cell broadcasts a dedicated neighbor frequency list over a dedicated frequency. Additionally, the serving cell may not broadcast public or macro neighbor frequency lists over the dedicated frequency. Optionally, in another aspect, the dedicated neighbor frequency list is not broadcast from a serving cell in a public or macro frequency. A dedicated base station may broadcast a neighbor list including only other dedicated frequencies.

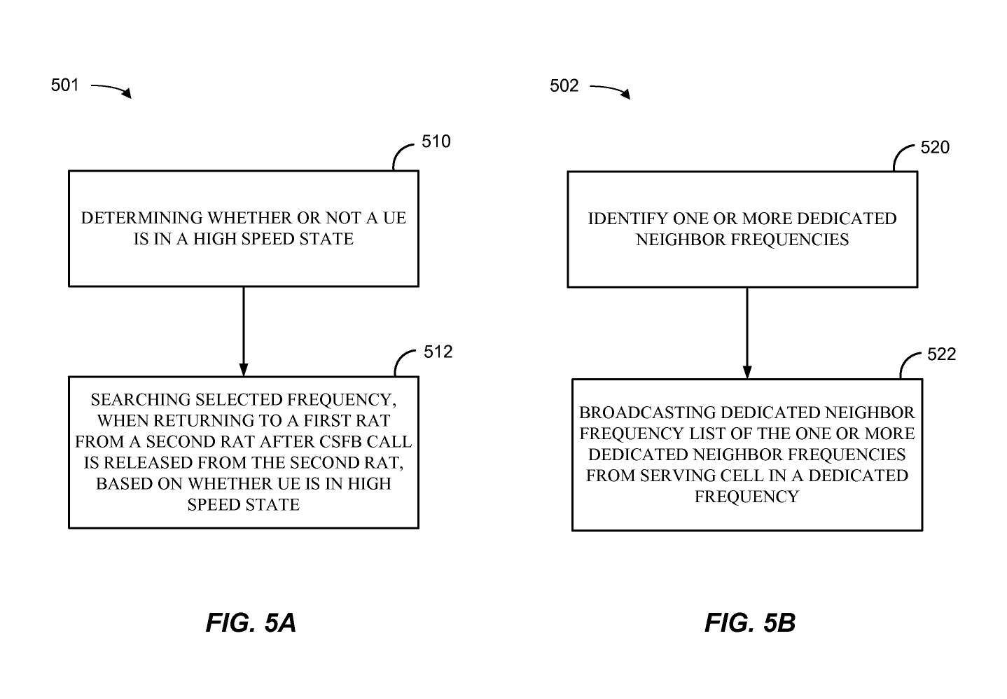

FIG. 5A shows a wireless communication method 501 according to one aspect of the disclosure. A UE determines whether a user equipment (UE) is in a high speed state, as shown in block 510. The UE also searches a selected frequency, when returning to a first radio access technology (RAT) from a second RAT after a circuit switched fallback (CSFB) call is released from the second RAT, based on whether the UE is in a high speed state, as shown in block 512.

FIG. 5B shows a wireless communication method 502 according to one aspect of the disclosure. A serving base station identifies one or more dedicated neighbor frequencies, as shown in block 520. The serving base station broadcasts a dedicated neighbor frequency list of the at least one dedicated neighbor frequency over a serving cell in a dedicated frequency, as shown in block 522.

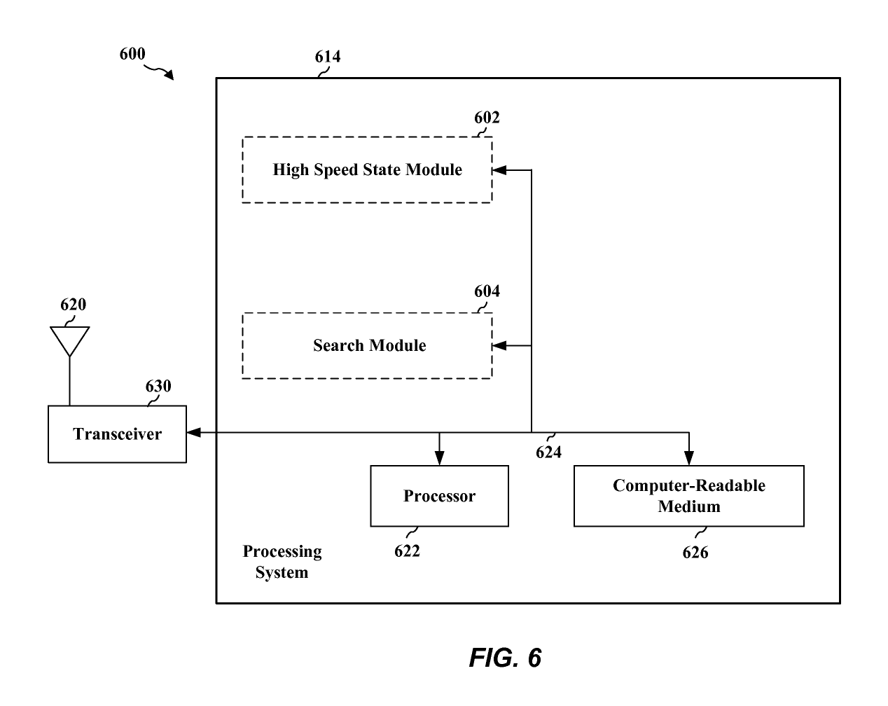

FIG. 6 is a diagram illustrating an example of a hardware implementation for apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 may be a component of the UE 350 and may include the memory 392, and/or the controller/processor 390. Additionally, the processing system 614 includes a high speed state module 602 for determining whether a UE is in a high speed state. The processing system 614 includes a search module 604 for searching a selected frequency. The modules may be software modules running in the processor 622, resident/stored in the computer-readable medium 626, one or more hardware modules coupled to the processor 622, or some combination thereof

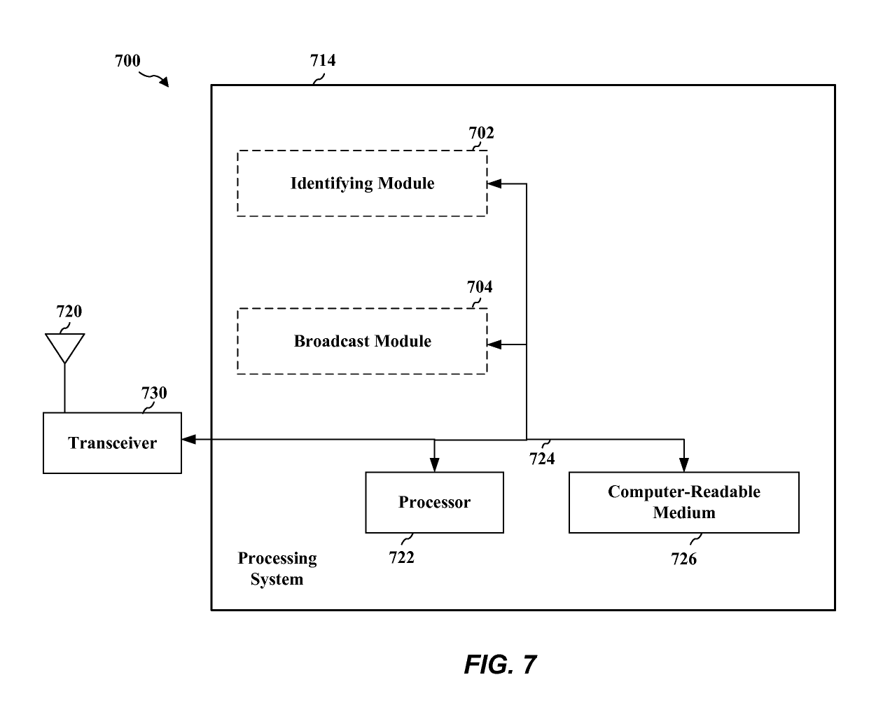

FIG. 7 is a diagram illustrating an example of a hardware implementation for apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 may be a component of the node B 310 and may include the memory 342, and/or the controller/processor 340. Further, the processing system 714 may include an identifying module 702 to identify one or more dedicated neighbor frequencies. The processing system 714 may also include a broadcast module 704 to broadcast a dedicated neighbor frequency list of the one or more dedicated neighbor frequencies over a serving cell in a dedicated frequency. The modules may be software modules running in the processor 722, resident/stored in the computer-readable medium 726, one or more hardware modules coupled to the processor 722, or some combination thereof.

In one configuration, an apparatus such as a UE is configured for wireless communication including means for determining In one aspect, the determining means may be the controller/processor 390, the memory 392, high speed state module 391, high speed state module 602 and/or the processing system 614 configured to perform the determining means. The UE is also configured to include means for searching. In one aspect, the searching means may be the antennas 352, the receiver 354, the channel processor 394, the receive frame processor 360, the receive processor 370, the transmitter 356, the transmit frame processor 382, the transmit processor 380, the controller/processor 390, the memory 392, high speed state module 391, search module 604 and/or the processing system 614 configured to perform the searching means. In one configuration, the means functions correspond to the aforementioned structures. In another aspect, the aforementioned means may be a module or any apparatus configured to perform the functions recited by the aforementioned means.

In one configuration, an apparatus such as a node B is configured for wireless communication including means for identifying. In one aspect, the identifying means may be the antennas 334/720, the receiver 335, the transceiver 730, the channel processor 344, the receive frame processor 336, the receive processor 338, the controller/processor 340, the memory 342, the dedicated neighbor frequency list module 341, the identifying module 702, and/or the processing system 714 configured to perform the aforementioned means. The node B is configured for wireless communication including means for broadcasting. In one aspect, the broadcasting means may be the antennas 334, the transmitter 332, the transmit frame processor 330, the transmit processor 320, the controller/processor 340, the memory 342, dedicated neighbor frequency list module 341, broadcast module 704, and/or the processing system 714 configured to perform the broadcasting means. In another aspect, the aforementioned means may be a module or any apparatus configured to perform the functions recited by the aforementioned means.

Several aspects of a telecommunications system has been presented with reference to TD-SCDMA, GSM, and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Seyfarth Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a UE (user equipment) is in a high speed state; and
searching a selected frequency, when returning to a first RAT (radio access technology) from a second RAT after a CSFB (circuit switched fallback) call is released from the second RAT, based at least in part on whether the UE is in the high speed state.

2. The method of claim 1, in which the selected frequency comprises a prior serving dedicated frequency before the CSFB (circuit switched fallback) call, regardless of whether the prior serving frequency is a strongest frequency, when the UE is in the high speed state.

3. The method of claim 2, further comprising searching inter-frequency neighbors of the prior dedicated serving frequency when the prior dedicated frequency is below a predefined signal strength.

4. The method of claim 1, in which the selected frequency comprises a strongest frequency in a history associated with the first RAT when the UE is not in the high speed state.

5. The method of claim 1, in which the determining is based at least in part on whether a parameter is above a threshold, and in which the parameter is one of: a UE measured Doppler frequency or a speed indicated by a positioning location receiver.

6. The method of claim 1, further comprising recording a serving frequency and neighbor frequencies in a memory of the UE when the UE is in the high speed state.

7. The method of claim 1, further comprising recording only dedicated frequencies in a first database and recording all frequencies in a second database.

8. A method of wireless communication, comprising:
broadcasting a dedicated neighbor frequency list over a serving cell in a dedicated frequency.

9. The method of claim 8, further comprising not broadcasting public or macro neighbor frequency lists over the serving cell in the dedicated frequency.

10. The method of claim 8, further comprising not broadcasting a dedicated neighbor frequency list over the serving cell in a public or macro frequency.

11. An apparatus for wireless communication, comprising:
a memory; and
at least one processor coupled to the memory and configured:
to determine whether a UE (user equipment) is in a high speed state; and
to search a selected frequency, when returning to a first radio access technology (RAT) from a second RAT after a circuit switched fallback (CSFB) call is released from the second RAT, based at least in part on whether the UE is in the high speed state.

12. The apparatus of claim 11, in which the selected frequency comprises a prior serving dedicated frequency before the CSFB call, regardless of whether the prior serving frequency is a strongest frequency, when the UE is in the high speed state.

13. The apparatus of claim 12, in which the at least one processor is further configured to search inter-frequency neighbors of the prior dedicated serving frequency when the prior dedicated frequency is below a predefined signal strength.

14. The apparatus of claim 11, in which the selected frequency comprises a strongest frequency in a history associated with the first RAT when the UE is not in the high speed state.

15. The apparatus of claim 11, in which the at least one processor is further configured to determine based at least in part on whether a parameter is above a threshold, and in which the parameter is one of: a UE measured Doppler frequency or a speed indicated by a positioning location receiver.

16. The apparatus of claim 11, in which the at least one processor is further configured to record a serving frequency and neighbor frequencies in a UE memory when the UE is in the high speed state.

17. The apparatus of claim 11, in which the at least one processor is further configured to record only dedicated frequencies in a first database and recording all frequencies in a second database.

18. An apparatus for wireless communication, comprising:
a memory; and
at least one processor coupled to the memory and configured:
to broadcast a dedicated neighbor frequency list over a serving cell in a dedicated frequency.

19. The apparatus of claim 18, in which the at least one processor is further configured to avoid broadcasting public or macro neighbor frequency lists over the serving cell in the dedicated frequency.

20. The apparatus of claim 18, in which the at least one processor is further configured to avoid broadcasting a dedicated neighbor frequency list over the serving cell in a public or macro frequency.
